(19) United States
(12) Patent Application Publication
(10) Pub. No.: US 2026/0319514 A1
(43) Pub. Date: Oct. 15, 2026

(54) TRAVERSAL RISK GRAPH-BASED ROBOT PATH PLANNING

(71) Applicant: Korea Advanced Institute of Science and Technology, Daejeon (KR)

(72) Inventors: Hyun Myung, Daejeon (KR); Dongkyu Lee, Daejeon (KR); Byeongho Yu, Daejeon (KR); Minho Oh, Daejeon (KR); I Made Aswin Nahrendra, Daejeon (KR); Jiwon Park, Daejeon (KR); Taeyun Kim, Daejeon (KR)

(73) Assignee: Korea Advanced Institute of Science and Technology, Daejeon (KR)

(21) Appl. No.: 19/303,759

(22) Filed: Aug. 19, 2025

(30) Foreign Application Priority Data
Apr. 2, 2025 (KR) 10-2025-0042701

(51) Int. Cl. G05D 1/644; G05D 1/246; G05D 109/12

(52) U.S. Cl. CPC G05D 1/644; G05D 1/2462; G05D 2109/12

(57) ABSTRACT

Disclosed is a method of traversal risk graph-based robot path planning, the method including generating a plurality of paths by connecting a plurality of nodes of the terrain on which a robot is capable of standing and two nodes among the plurality of nodes as an edge, and generating a traversal risk graph (TRG) by considering reachability of the robot to a target node and terrain characteristics; and searching for a path used for the robot to reach the target node based on the traversal risk graph.

### CROSS-REFERENCE TO RELATED APPLICATION(S)

This application claims the priority benefit of Korean Patent Application No. 10-2025-0042701, filed on Apr. 2, 2025, in the Korean Intellectual Property Office, the disclosure of which is incorporated herein by reference.

### BACKGROUND

### 1. Field of the Invention

Example embodiments relate to a method for robot path planning, and more particularly, to a method for traversal risk graph-based robot path planning that may consider the risk and reachability of a path entry direction of a robot in an unstructured environment in terms of navigation of a walking robot.

### 2. Description of the Related Art

Robots that may move on various terrains are being developed. In unidentified unstructured terrains rather than pre-recognized structured terrains, it is important for autonomous navigation of a robot to explore which terrain the robot may move through and to recognize a model for that terrain.

Successful path planning on the conventional map focuses on finding a safe shortest distance. In two-dimension, a safe path is a path that may be traveled from a starting point to a destination point without collisions with obstacles. However, the existing robot path planning is difficult to apply in an unstructured environment such as mountains. In the unstructured environment, terrains are not uniform, so the safety of a path is affected by steepness or roughness of the terrains. Such environmental characteristics need to be considered in a walking robot that may traverse a variety of terrains.

Also, when planning a path of the robot, the risk may vary depending on in which direction of terrains the robot enters. For example, entering a slope from the side may make the robot more unstable than entering the slope from the front. The conventional method may not take this relative risk into account. Therefore, a new approach is required to prevent unnecessary resource consumption by calculating the risk of terrains in areas that the walking robot may not reach, and to perform safe and efficient path planning of the robot.

Patent Document 0001 includes KR 10-2023-0137080 A (2023.10.04.).

### SUMMARY

Example embodiments are conceived to solve the aforementioned issues and provide a method for traversal risk graph-based robot path planning that may efficiently sample and manage only safe areas in which a robot may actually move, and may calculate a travel path of the robot by applying terrain stability and slope characteristics.

Also, example embodiment provide a method for traversal risk graph-based robot path planning that may increase safety by integrally considering the relative risk between an angle of slope and a travel direction, may reduce unnecessary terrain analysis by generating a graph in a wavefront format, and may secure real-time performance by partially updating information around a robot.

Also, example embodiments provide a method for robot path planning that enables safe autonomous walking in an unstructured environment, such as mountains and disaster area, by updating a traversal risk graph for surrounding terrains in real time, regardless of presence or absence of a prior map.

Subjects to be solved by the invention are not limited to the contents described above and still other technical subjects not described herein will be clearly understood by one of ordinary skill in the art from the description set forth herein.

According to an example embodiment, there is provided a method for traversal risk graph-based robot path planning, the method including generating a plurality of paths by connecting a plurality of nodes of the terrain on which a robot is capable of standing and two nodes among the plurality of nodes as an edge, and generating a traversal risk graph (TRG) by considering reachability of the robot to a target node and terrain characteristics; and searching for a path used for the robot to reach the target node based on the traversal risk graph.

Also, the generating of the traversal risk graph may include determining whether each of the nodes is valid based on environmental information that includes the height of the terrain and movement stability of the robot, and removing an invalid node.

Also, the determining whether the node is valid may include comparing the node and the median of the terrain height, and evaluating and determining whether the robot is capable of standing without losing its balance.

Also, the generating of the traversal risk graph may include calculating the traversal risk of the robot by performing elliptical plane approximation for the edge, removing an edge of which the risk exceeds a preset reference value, and generating the traversal risk graph that allows the robot to safely move.

Also, the traversal risk may be calculated by considering an angle of slope of the elliptical plane extracted through principal component analysis (PCA).

Also, in response to expansion from a reference node in a wavefront manner, the traversal risk graph may be expanded to an area reachable from a location of the robot and thereby generated by progressively sampling a surrounding area at the reference node and by recursively connecting the edge.

Also, an expansion method in the wavefront manner to generate and manage the traversal risk graph may be to sample an adjacent area at the reference node of the robot, to merge nodes close by a predetermined distance or less from the reference node, and to connect an edge between the nodes.

Also, the method may further include updating a local graph based on terrain information corresponding to a sensor measurement range of the robot and reflecting the same to a global graph, to respond to a dynamic environmental change around the robot.

Also, the searching for the path may include searching for the path using a cost function.

Also, the cost function may be calculated in consideration of a length of a path candidate group of the edge and the traversal risk.

Also, the cost function may include a heuristic function based on a distance from the target node.

Also, to minimize the cost function on the traversal risk graph, search may be performed by calculating an arrival cost and an estimated heuristic cost for each node and search priority of a path in which the traversal risk of the edge is higher than a predetermined reference is lowered.

Also, when the traversal risk of the edge exceeds a reference value, the edge may be removed or the priority may be lowered to exclude the edge when searching for a travel path.

Also, when a new obstacle is detected or existing terrain information changes while the robot is walking, the traversal risk graph may generate real-time path planning by partially updating information on nodes and edges connected to the corresponding terrain.

According to an example embodiment, there is provided a device for generating traversal risk graph-based robot path planning, the device including a memory including measurement data of a sensor mounted to a robot and a computer-readable instruction; and a processor configured to perform terrain map generation by processing the instruction, wherein the processor is configured to generate a plurality of paths by connecting a plurality of nodes of the terrain on which a robot is capable of standing and two nodes among the plurality of nodes as an edge, and generating a traversal risk graph (TRG) by considering reachability of the robot to a target node and terrain characteristics, and to search for a path used for the robot to reach the target node based on the traversal risk graph.

Also, the processor may be configured to generate the traversal risk graph by determining whether each of the nodes is valid based on environmental information that includes the height of the terrain and movement stability of the robot and by removing an invalid node.

Also, the processor may be configured to search for the path using a cost function that considers a length of the path and the traversal risk together.

According to some example embodiments, there may be provided a method for traversal risk graph-based robot path planning that may efficiently sample and manage only safe areas in which a robot may actually move, and may calculate a travel path of the robot by applying terrain stability and slope characteristics.

Also, according to some example embodiments, there may be provided a method for traversal risk graph-based robot path planning that may increase safety by integrally considering the relative risk between an angle of slope and a travel direction, may reduce unnecessary terrain analysis by generating a graph in a wavefront manner, and may secure real-time performance by partially updating information around a robot.

Also, according to some example embodiments, there may be provided a robot path planning method that enables safe autonomous walking in an unstructured environment, such as mountains and disaster area, by updating a traversal risk graph for surrounding terrains in real time, regardless of presence or absence of a prior map through efficient traversal risk graph management.

Effects of the invention are not limited to the contents described above and still other effects not described herein will be clearly understood by one of ordinary skill in the art from the description set forth herein.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates a quadruped walking robot according to an example embodiment;

FIG. 2 is a block diagram illustrating a configuration of a traversal risk graph-based robot path planning device according to an example embodiment;

FIG. 3 is a flowchart illustrating a traversal risk graph-based robot path planning method according to an example embodiment;

FIG. 4 illustrates a process of performing a traversal risk graph-based robot path planning method according to an example embodiment;

FIG. 5 illustrates an example of describing risk calculation based on edges approximated to an ellipse and their characteristics in a traversal risk graph according to an example embodiment;

FIG. 6 illustrates an example of expanding a graph using a wavefront scheme from a reference node in a traversal risk graph according to an example embodiment;

FIGS. 7A, 7B and 7C illustrate an example of hierarchically managing a global traversal risk graph (TRG) and a local TRG according to an example embodiment;

FIGS. 8A and 8B illustrate a mountain environment simulation environment constructed for an experiment according to a traversal risk graph-based robot path planning method according to an example embodiment;

FIG. 9 illustrates a success rate of path planning and a completion success rate when following a planned method, and a path planning operation time for each scenario in a simulation of a traversal risk graph-based robot path planning method according to an example embodiment;

FIG. 10 illustrates path planning according to a simulation of a traversal risk graph-based robot path planning method according to an example embodiment;

FIG. 11 illustrates an example of a robot that finds safe terrains in a mountain environment and generating a path according to a traversal risk graph-based robot path planning method according to an example embodiment; and

FIG. 12 illustrates experimental results for each algorithm in a hill environment with different entry slopes according to a traversal risk graph-based robot path planning method according to an example embodiment.

### DETAILED DESCRIPTION

Hereinafter, example embodiments of the invention are described in detail with reference to the accompanying drawings, such that one of ordinary skill in the art to which the invention pertains may easily implement the invention. However, the invention may be implemented in various different forms and is not limited to the example embodiments described herein. In the drawings, parts that are irrelevant to the description are omitted to clearly describe the example embodiments.

The terms used herein are simply used to explain a specific example embodiment and are not construed as limiting the invention. The singular expression may include the plural expression unless the context clearly indicates otherwise.

It will be further understood that the terms “comprises” and/or “comprising,” when used in this specification, specify the presence of stated features, integers, steps, operations, elements, components, and/or combinations thereof, but do not preclude the presence or addition of one or more other features, integers, steps, operations, elements, components, and/or combinations thereof.

Also, components shown in example embodiments are independently illustrated to represent different characteristic functions and do not indicate that each of the components is implemented as separate hardware or a single software configuration unit. That is, each component is described by listing each component for clarity of description, and at least two components among the components may be integrated into a single component or a single component may be divided into a plurality of components, to perform a function. An integrated example embodiment and separate example embodiment of each component is also included in the scope of the invention as far as it does not depart from the spirit of the invention.

Also, the following example embodiments are provided to provide clearer explanation to one of ordinary skill in the art, and shapes and sizes of components in the drawings may be exaggerated for clearer explanation.

Hereinafter, example embodiments will be described with reference to the accompanying drawings.

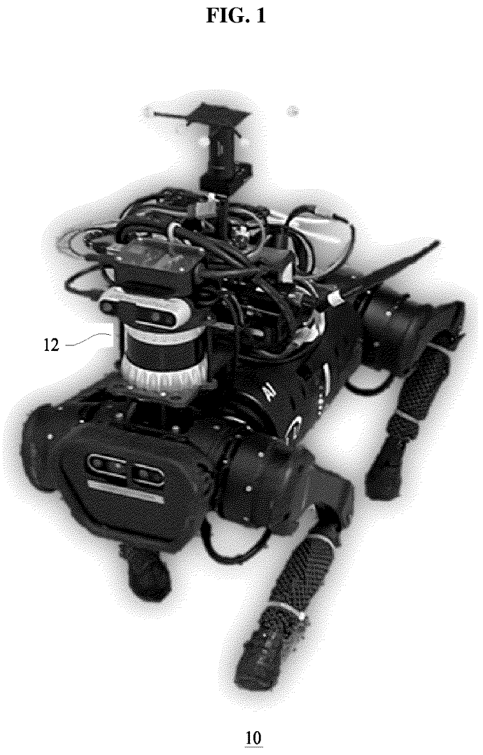

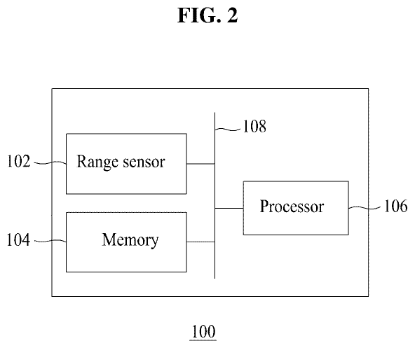

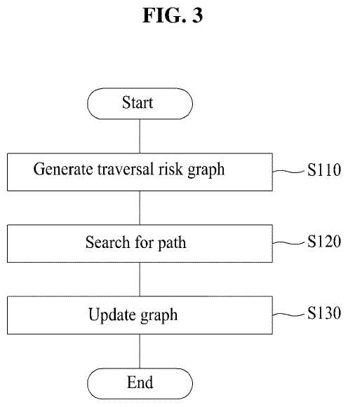

FIG. 1 illustrates a quadruped walking robot according to an example embodiment, and FIG. 2 is a block diagram illustrating a configuration of a traversal risk graph-based robot path planning device according to an example embodiment. FIG. 3 is a flowchart illustrating a traversal risk graph-based robot path planning method according to an example embodiment.

Initially, referring to FIG. 1, a robot 10 according to an example embodiment refers to, for example, a quadruped walking robot, and may identify a shape of unstructured terrain using a range sensor 102 and may determine waling probability and move. The quadruped walking robot 10 may be equipped with various sensors 12. For example, the sensor 12 may include light detection and ranging (LiDAR), a camera, a radar, and an inertial measurement unit (EIU). The quadruped walking robot 10 may identify a location and state of the robot 10 and surrounding terrains using the sensors 12, and may calculate the risk according to movement and walking probability.

Referring to FIGS. 2 and 3, a traversal risk graph-based robot path planning device 100 according to an example embodiment may be implemented in a hardware type or a software type, and may be mounted to a mobile platform such as the robot 10 and may estimate a location of the robot 10 and may create a map. That is, the robot path planning device 100 may establish a graph that may consider the risk and reachability of a path entry direction of the quadruped walking robot 10 in an unstructured environment and path planning based on the graph. To this end, the robot path planning device 100 according to an example embodiment may include at least one processor 106, a computer-readable memory 104, and a communication bus 108. The processor 106 may control the robot path planning device 100 to operate. For example, the processor 106 may execute at least one program stored in the memory 104. The at least one program may include at least one computer-executable instruction, and the computer-executable instruction, when executed by the processor 106, may be configured to cause the robot path planning device 100 to store computer-executable instructions and program codes, program data, and measurement data of the ranger sensor 102 to analyze the terrain on which the robot 10 is standing, and to generate a traversal risk graph (TRG) that simultaneously reflects target point reachability of the robot 10 and characteristics of the terrain. The program stored in the memory 104 may include a set of instructions executable by the processor 106. The communication bus 108 may interconnect various other components of the robot path planning device 100, including the processor 106 and the memory 104. Also, the range sensor 102 may be connected to other components of the robot path planning device 100 through the communication bus 108. The memory 104 may store data acquired from various range sensors 12 mounted to a robot platform, for example, the quadruped walking robot 10.

In this example embodiment, although the quadruped walking robot is used as an example, it may also be applied to a bipedal upright walking robot and other types of moving platforms. The walking robot 10 may acquire information on surrounding terrains using, for example, the range sensor 102 such as a camera and LiDAR when the robot 10 is moving on the terrain.

FIG. 3 is a flowchart illustrating a traversal risk graph-based robot path planning method according to an example embodiment. A traversal risk graph-based robot path planning method (S100) according to an example embodiment may include operation S110 of generating a traversal risk graph, operation S120 of searching for a path, and operation S130 of updating a graph. The A traversal risk graph-based robot path planning method (S100) may be performed by the processor 106.

In operation S110 of generating the traversal risk graph, the processor 106 may generate a plurality of paths by connecting a plurality of nodes of the terrain on which the robot 10 may stand and two nodes among the plurality of nodes as an edge, and may generate a traversal risk graph (TRG) by considering reachability of the robot 10 to a target node and terrain characteristics. In operation S110, whether each node is valid may be determined based on environmental information that includes the height of the terrain height and evaluation on safety of the robot 10, and may remove an invalid node. Also, in operation S120 of searching for the path, the processor 106 may search for a path for the robot 10 to reach the target node based on the traversal risk graph (TRG). Hereinafter, each operation is described in more detail.

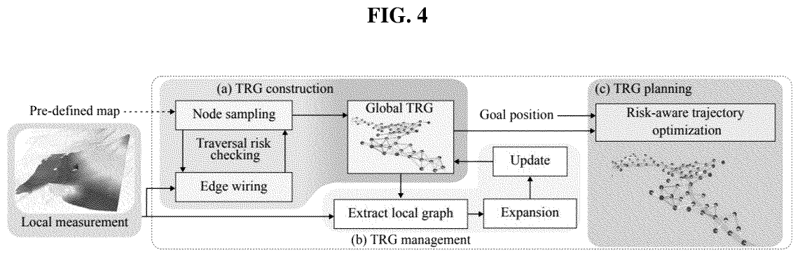

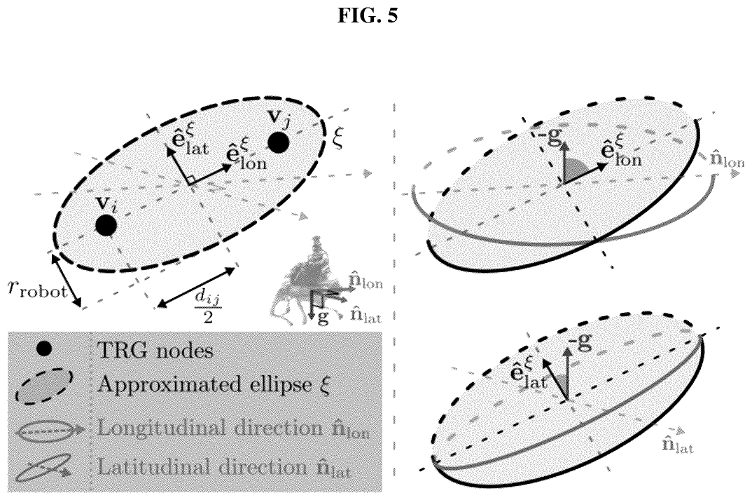

FIG. 4 illustrates a process of performing a traversal risk graph-based robot path planning method according to an example embodiment, and FIG. 5 illustrates an example of describing risk calculation based on edges approximated to an ellipse and their characteristics in a traversal risk graph according to an example embodiment.

Referring to FIGS. 3 and 4, the traversal risk graph (TRG) according to an example embodiment may represent a graph structure configured with edges that connect path candidates between two terrains by using the terrain that the robot 10 may safely reach is represented as a node. In this structure, the nodes may reflect characteristics of the terrain on which the robot 10 may actually stand, and the edges may approximate the path candidates that connect two terrains to the elliptical plane, thereby quantifying the traversal risk of the robot 10. The processor 106 may dynamically evaluate the relative risk that varies depending on not only presence or absence of an obstacle in the travel path of the robot 10, but also a gradient of the terrain and a travel direction of the robot 10, and may reflect the same to the traversal risk graph.

As shown in FIG. 4, the processor 106 of the traversal risk graph-based robot path planning device 100 according to an example embodiment may primarily generate a TRG. Here, each node represents the terrain on which the robot 10 may stand, and presence of a node represents an area reachable from a current location of the robot 10. This may be calculated as Equation 1 below.

$$g ( {c}_{i} ) = 𝟙 \{ ∀ h ( {x}_{k} , {y}_{k} ) : \vert h ( {x}_{k} , {y}_{k} ) - {h}_{mid} \vert < {h}_{max} \} , \qquad [ Equation 1 ]$$

$$r ( {E}_{i} ) = 𝟙 \{ n ( {E}_{i} ) > 0 \} ,$$

Here, the function g(cᵢ) may compare each height h(xₖ,yₖ) of the terrain represented by a node and the median height h_{mid} of the total height and may determine whether the terrain is safe for the robot 10 to stand on without losing its balance. Also, the function r(Ei) may verify that the robot 10 may reach a corresponding node when at least one edge is connected to the node.

To determine whether the corresponding terrain is safe for the robot 10, the processor 106 may compare terrain height information and the median height. Also, only when at least one edge is connected, the corresponding node may be considered to be actually reachable by the robot 10. Through this process, a valid node that considers both safety and reachability may be determined. In more detail, as in a conditional expression in Equation 2 below, only a state sᵢ of a node that simultaneously satisfies two conditions is a valid node and other nodes may be distinguished as invalid nodes. Through this, terrain information may be effectively expressed.

$${s}_{i} = \{ \begin{matrix}valid , & if g ( {c}_{i} ) ⋀ r ( {E}_{i} ) , \\ invalid , & otherwise\end{matrix} . \qquad [ Equation 2 ]$$

Referring to FIG. 5, an edge of the traversal risk graph (TRG) connects two nodes and may be used to calculate a path candidate group through which the robot 10 may actually move. As shown in FIG. 5, the processor 106 may extract geometric characteristics related to a slope and a direction by approximating the path candidate group to the elliptical plane through principal component analysis (PCA). For example, through the main axis acquired by the PCA, a tilt of the path and an angle between the path and the driving direction of the robot 10 may be identified. The traversal risk represented by the corresponding path candidate group may be defined by Equation 3 below, and an excessively risky edge may be deleted.

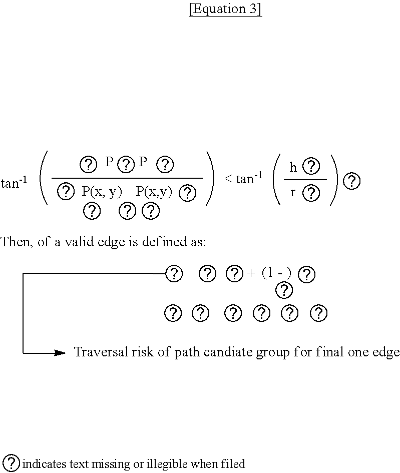

Here, the terrain is modeled in a form of an edge that includes two nodes, and the nodes are expressed as vᵢ, vⱼ, the edge is expressed as eᵢⱼ, pᵢ(z) denotes a z value of the node vᵢ, that is, a height value, and pᵢ (x,y) denotes x and y values of vᵢ.

Also, in Equation 3, a left term represents the slope of the edge, and the right term represents the maximum slope of the edge using the size of the robot (r_{robot}) and the maximum height that may be overcome (hₘₐₓ). Since all the edges need to satisfy Equation 3 above, the slope needs to be maintained to be lower than the maximum slope.

If a valid edge is formed by satisfying Equation 3 above, the edge may have a weight (wᵢⱼ) and the weight may represent the potential risk that the robot 10 may face when passing through the edge path. wᵢⱼ is acquired as the weighted average of two terms, and its weight may be expressed as γ. The two terms refer to

$${ℛ}_{lon}^{ξ} , {ℛ}_{lat}^{ξ} ,$$

which are numerical values that represent the path risk in a heading direction (longitudinal direction) of the path and a direction (latitudinal direction) perpendicular to the heading direction of the path, respectively. Also, each

$${\hat{e}}_{dir}^{ξ}$$

term represents a normalized eigenvector of the corresponding directional edge plane. The risk may be expressed as the inner product between a normalized eigenvector

$$( {\hat{e}}_{dir}^{ξ} )$$

and a gravity vector g=(0, 0, −1), and the qualitative meaning of the risk may represent the probability that the robot 10 may fall when moving in the corresponding direction along the corresponding path.

Describing in more detail with reference to FIG. 5, FIG. 5 is expressed as three axes based on a travel direction of the robot 10, and represents a longitudinal direction vector \hat{n}ₗₒₙ, a latitudinal direction vector \hat{n}ₗₐₜ, and a gravity direction vector g. An edge may be constituted in the elliptical plane using a principal component analysis (PCA) method based on two nodes (vᵢ, vⱼ). Here, r_{robot} denotes the size of the robot 10 and dᵢⱼ denotes a distance between two nodes. Here, the eigenvector of the elliptical plane is expressed as

$${\hat{e}}_{dir}^{ξ} ,$$

and an upper right (longitudinal) picture and a lower right (latitudinal) picture express angles relative to the heading direction of the robot 10, respectively.

Then, the processor 106 may calculate the traversal risk by synthesizing relationship between the slope of the elliptical plane and the robot direction, ground roughness, and the like, and if a numerical value of the calculated traversal risk exceeds a threshold, may determine that the edge has the high risk and may remove the edge from the graph.

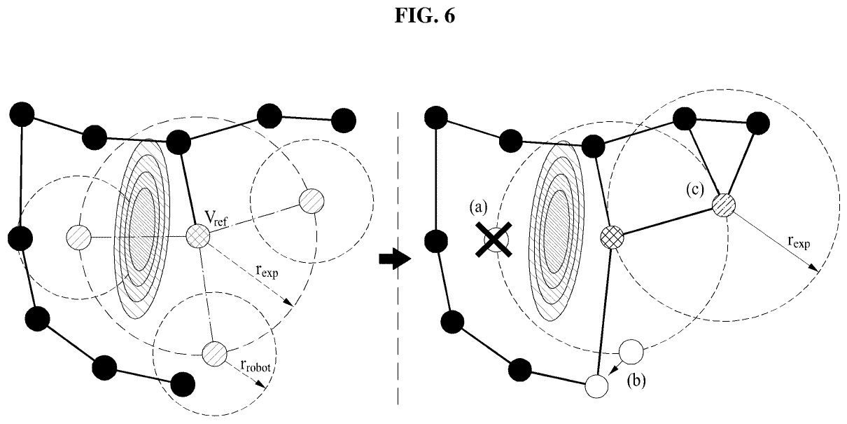

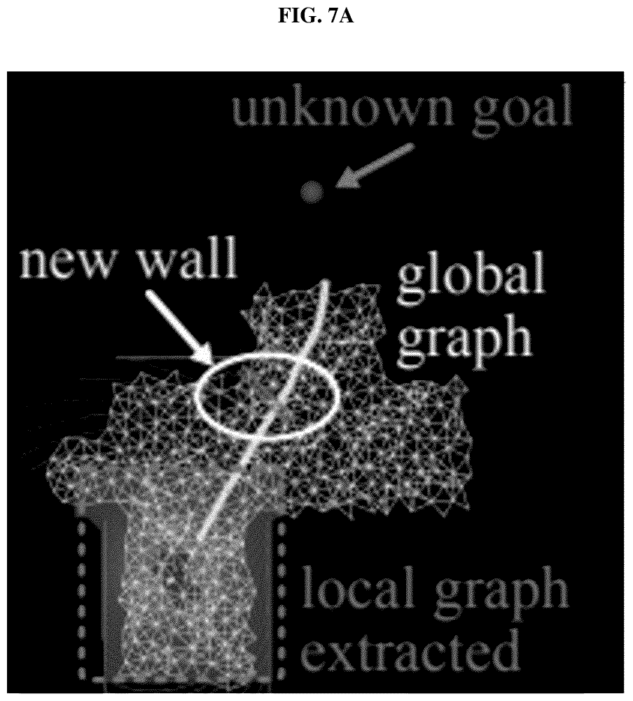

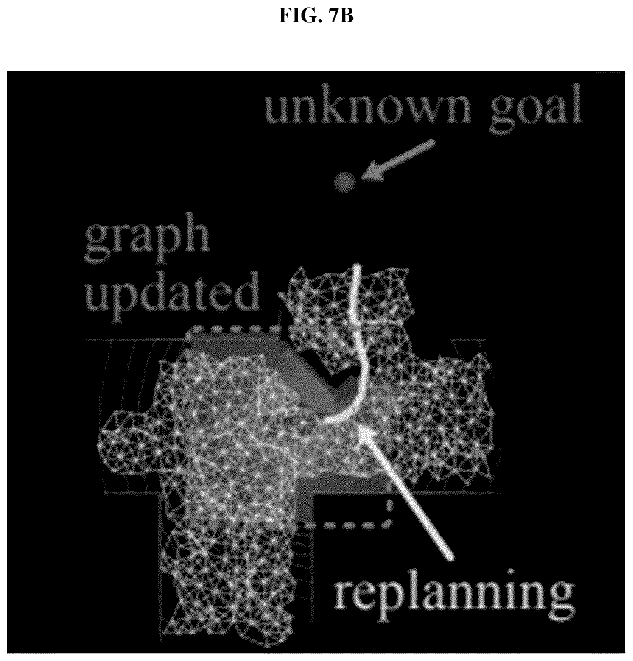

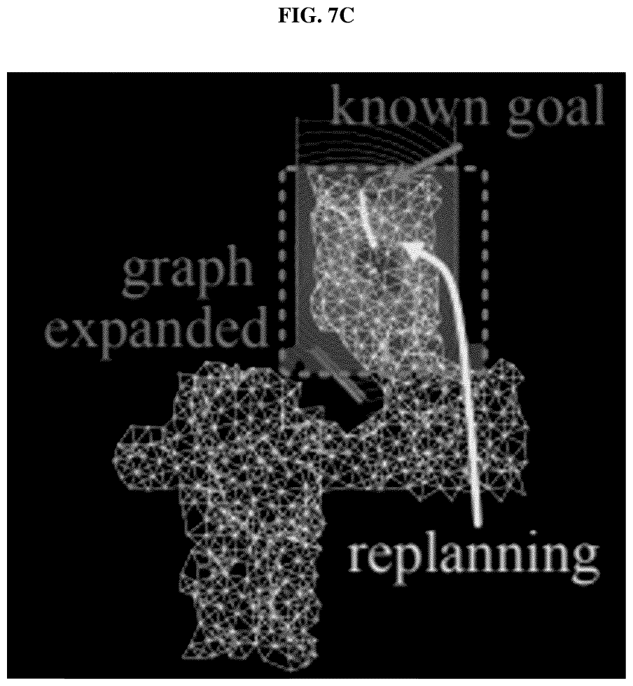

FIG. 6 illustrates an example of expanding a graph using a wavefront scheme from a reference node in a traversal risk graph according to an example embodiment. FIGS. 7A, 7B and 7C illustrate an example of hierarchically managing a global TRG and a local TRG according to an example embodiment.

Referring to FIGS. 4 and 6, the processor 106 may perform expansion and management of the traversal risk graph. In FIG. 6, (a) shows that no node and edge are generated as an immovable area, (b) shows that existing adjacent nodes are present and nodes are merged and connected by an edge, and (c) shows that a node is generated and connected with adjacent nodes by an edge as a new area.

The processor 106 may perform expansion and management of the traversal risk graph, and may gradually generate and expand the traversal risk graph by borrowing a method in which the wavefront spreads based on a current location of the robot 10, which differs from a global graph construction method used in an existing probabilistic roadmap (PRM). As shown in the example of FIG. 6, the processor 106 may perform sampling around a reference node, and, when the corresponding terrain is valid, may generate a new node or merge with the existing node, and then may recursively connect the edge. This forms a graph only within the actual movement range of the robot 10, so calculation for an unnecessary area may be excluded, which may improve the resource utilization. The expansion method in the wavefront manner may sample an adjacent area at the reference node of the robot 10, may merge nodes close by a predetermined distance or less from the reference node, and may connect an edge between the nodes.

Referring to FIGS. 7A, 7B and 7C, the processor 106 may perform a hierarchical management for the traversal risk graph into a local graph and a global graph. FIG. 7A represents extracting a local graph corresponding to robot observation information, FIG. 7B represents regenerating a path that avoids an obstacle by updating a changed portion of an existing graph, and FIG. 7C represents expanding the existing graph to successfully reach a destination when the robot 10 reaches an unknown area. When new sensor data is received in response to the robot 10 moving, the processor 106 may extract the local graph only within this range. As shown in FIGS. 7A, 7B and 7C, the processor 106 may quickly update the changed terrain (e.g., when a new obstacle is found or when a shape of the existing terrain is changed due to remeasurement) around the robot 10, and may update risk information of edges or nodes connected to the area. Whenever the local graph is updated, only a necessary part is reflected to the entire graph, the global graph. Therefore, a dynamic environmental change may be continuously tracked without a need to regenerate the entire graph structure. This may be extremely useful in disaster response or industrial sites in which real-time performance is important.

Referring to (c) of FIG. 4, in an example embodiment, the processor 106 may design a cost function for path search of the robot 10. Since each edge of the traversal risk graph has a length of a path candidate group and traversal risk, the processor 106 may design a new cost function that simultaneously considers both the length and the traversal risk and may utilize the same for path search. The processor 106 may determine whether to select a shorter but riskier path or a safer path that may be a bit more detour. Since the cost function used in the existing methodology considers only a distance, it is not effective in finding a safe path. Therefore, by considering traversal risk information of the path candidate group contained in the traversal risk graph according to an example embodiment, the new cost function may be designed to enable path planning that allows the robot 10 to pass through the safe terrain (see (c) of FIG. 4). The new cost function may be calculated as shown in Equation 4 below.

$$C ( {v}_{i + 1} ) = C ( {v}_{i} ) + {d}_{i + 1 , i} ( Γ {w}_{i + 1 , i} + 1 ) , \qquad [ Equation 4 ]$$

$$J ( {v}_{i + 1} ) = C ( {v}_{i + 1} ) + ‖ {p}_{i + 1} - {p}_{goal} ‖ ,$$

Here, C(vᵢ₊₁) is the cost function from a starting node of path planning to a current search node, and is set to consider the length d_{i+1,i} of the path candidate group contained in the TRG edge and the traversal risk w_{i+1,i}. The elements allow a user to adjust whether to plan a fast shortest path or a safe but detouring path according to a safety factor Γ. Then, a final cost function J(vᵢ₊₁) that includes a distance-based heuristic function to a target node is derived and path planning may be performed through an optimization scheme that minimizes the final cost function.

In Equation 4 above, C(vᵢ₊₁) denotes a cost to reach a current node (vᵢ₊₁) being searched from a starting node, and ∥pᵢ₊₁−p_{goal}∥ denotes an estimated movement cost (heuristic function) from the current node being searched to the target node. Here, since the heuristic function may not calculate the movement cost of future nodes, the heuristic function may be set and used according to the purpose. For example, the straight-line distance from the search node to the target node may be used as the heuristic function to design nodes closer to the target node to have a lower cost. The processor 106 performs search by calculating the arrival cost and the estimated heuristic cost for each node to minimize the cost function on the traversal risk graph, and, here, may lower search priority of or remove a path with the traversal risk of an edge exceeding a predetermined reference value and may exclude the edge when searching for a travel path.

The traversal risk graph-based robot path planning method according to the aforementioned example embodiment may quantify the relative risk for the terrain and assign the same to each edge, may secure real-time performance through wavefront-based graph generation and hierarchical update, and may allow flexible path planning according to the user's goal (e.g., shortest distance priority vs safety priority) by adjusting a safety factor using a weight.

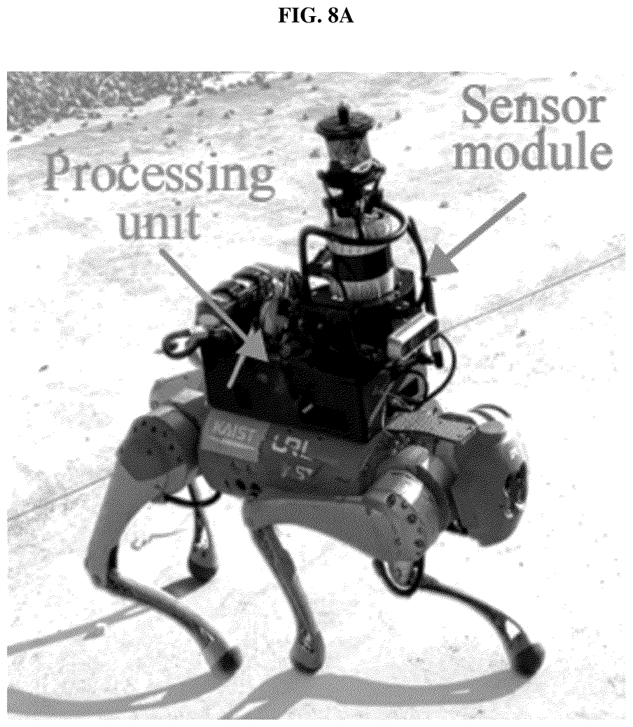

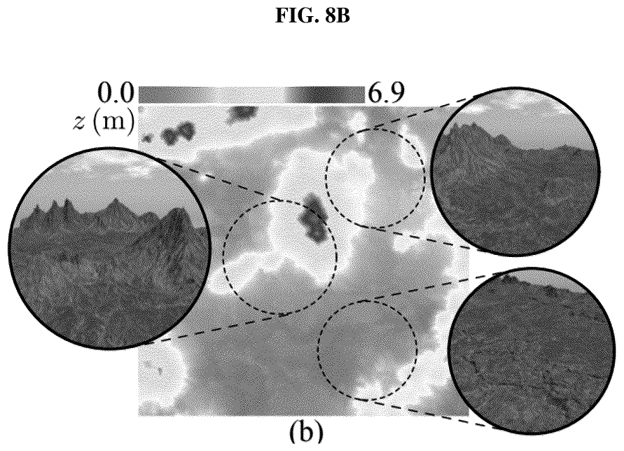

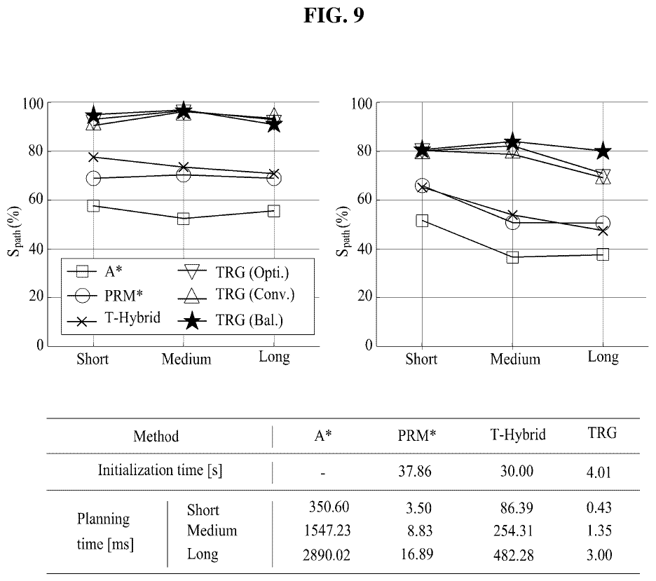

FIGS. 8A and 8B illustrate a mountain environment simulation environment constructed for an experiment according to a traversal risk graph-based robot path planning method according to an example embodiment, and FIG. 9 illustrates a success rate of path planning and a completion success rate when following a planned method, and a path planning operation time for each scenario in a simulation of a traversal risk graph-based robot path planning method according to an example embodiment.

As shown in FIGS. 8A and 8B, a virtual environment with steep slopes and rough surfaces was constituted to simulate the actual mountainous terrain. A quadruped walking robot model was placed on a simulator, and terrain information was set to be periodically acquired through a virtual sensor (LiDAR, stereo camera, IMU, etc.) mounted to this robot. Each experiment was conducted by randomly assigning a starting point and a target point and by using three distance categories short (10 m), medium (20 m), and long (30 m).

To compare with the traversal risk graph-based robot path planning method (TRG algorithm) according to an example embodiment, a representative search-based algorithm (A*), a graph-utilizing path planning method (PRM*), and latest algorithm T-Hybrid that considers traversal performance. Also, the TRG algorithm compared TRG (Optimistic, Conservative, Balance) strategies by safety strategy to verify the performance according to the safety factor of the cost function. As key performance indicators, a success rate of path generation, a completion success rate when the actual robot follows the path, and a computation time used for path generation were measured.

As can be seen in FIG. 9, the TRG algorithm according to an example embodiment shows a higher path generation rate than other algorithms in all distance categories, (short (10 m), medium (20 m), and long(30 m)). When the quadruped robot followed the generated path in the actual simulation, the completion success rate (success rate of travel) was also superior to those of other algorithms. This indicates that TRG reflects risk factors according to the terrain gradient and the travel direction, thereby minimizing an accident, such as fall and slip during actual walking. A table of FIG. 9 shows a time used to compute path planning time between the TRG algorithm and other algorithms. The TRG algorithm excludes an unnecessary terrain computation through a wavefront-based expansion and hierarchical graph management scheme, and shows that fast update and path search may be performed even in a dynamic environment. The TRG algorithm according to an example embodiment does not require a large cost for an initialization time when generating and utilizing a prior graph or map, and updates only an area around the robot whenever necessary. Therefore, it was found that a preliminary map construction time, required by existing PRM*, was relatively rare.

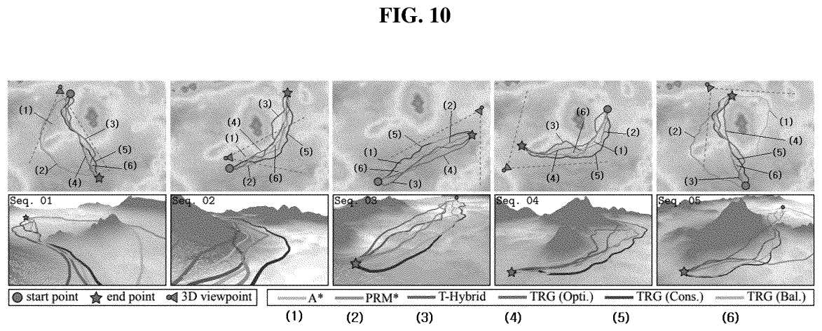

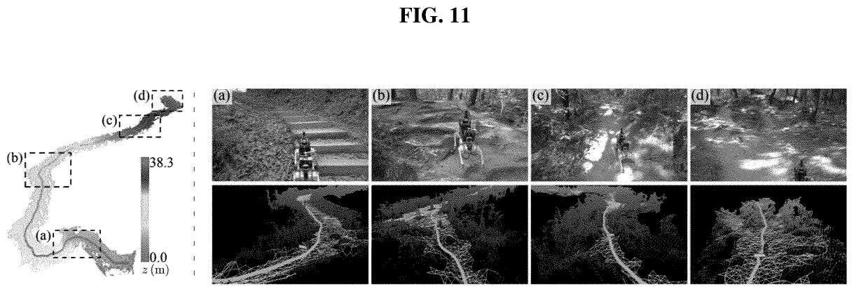

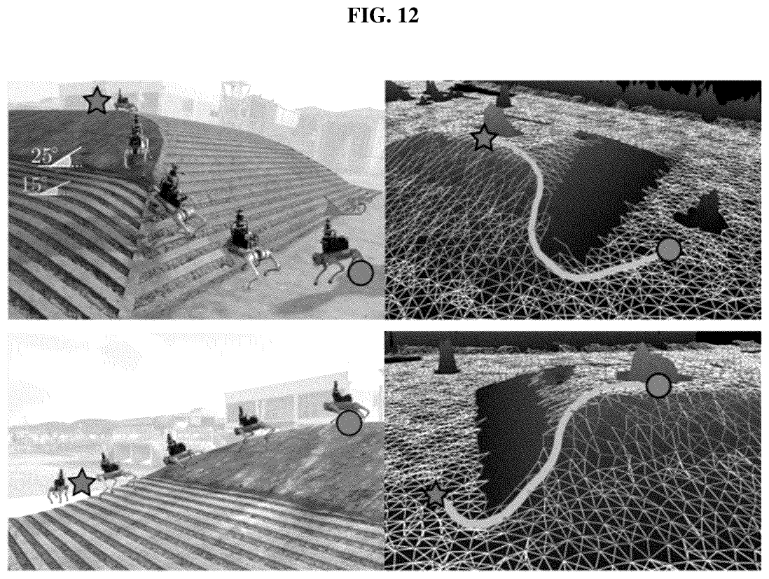

FIG. 10 illustrates path planning according to a simulation of a traversal risk graph-based robot path planning method according to an example embodiment, and FIG. 11 illustrates an example of a robot that finds safe terrains in a mountain environment and generating a path according to a traversal risk graph-based robot path planning method according to an example embodiment. FIG. 12 illustrates experimental results for each algorithm in a hill environment with different entry slopes according to a traversal risk graph-based robot path planning method according to an example embodiment.

FIG. 10 shows path planning results for five waypoints arbitrarily set on the simulation. In FIG. 10, a first line is a top view viewed from a contour map, and a second line is a bird-eye view viewed in a three-dimension (3D). The TRG algorithm (TRG(Opti.), TRG(Cons.), TRG(Bal.)) according to an example embodiment shows a short and safe form, that is, a path that does not take an excessive detour while avoiding steep terrain compared to other algorithms. In contrast, the existing algorithms (A*, etc.) prioritize a short distance and enter a steep slope, which makes the robot unstable or even slip off the path.

Referring to FIG. 11, verification was performed not only on simulations but also terrain data (length about 245 m, height 38.3 m) measured on actual mountain. As shown in FIG. 11, the analysis results regarding whether the robot may safely move through the steep terrains show that the robot successfully searches for a path to avoid obstacles and steep slopes by expanding and updating the traversal risk graph using only data around the robot, without a need to construct all of global information in advance.

FIG. 12 shows that the proposed hill environment is the continuous terrain with various slopes, and may be considered as an appropriate example for verifying the relative risk concept emphasized by the present invention. The TRG algorithm according to an example embodiment significantly reduces the risk of collision or overturning since the robot detours along a gentler slope rather than directly entering a side slope or a steep slope. On the other hand, the existing path planning often selects a risky section since a straight path is a shortest distance, which increases the probability of walking failure or robot turning over during actual driving.

As described above, through simulation and actual environmental experiments, it is verified that a TRG-based path planning method according to an example embodiment may generate a highly stable and efficient path even in an unstructured environment. In particular, by quantitively reflecting the relative risk of the terrain and by securing real-time performance using a wavefront-based graph expansion and hierarchical update method, it is possible to significantly reduce dependence on a prior map and to perform stable path planning.

The traversal risk graph-based robot path planning method according to the example embodiment described above may efficiently sample and manage only safe areas in which a robot may actually move, and may calculate a travel path of the robot by applying terrain stability and slope characteristics. Also, since the terrain in which the robot may actually stand and risk elements according to the travel direction of the robot are integrally considered, a safer path may be derived than the existing methodology and it is possible to significantly reduce overturning, slipping, and mis-stepping of the robot in an unstructured environment, and to increase an actual driving success rate of the robot.

Also, it is possible to increase safety by integrally considering the relative risk between an angle of slope and a travel direction, to reduce unnecessary terrain analysis by generating a graph in a wavefront manner, and to secure real-time performance by partially updating information around the robot.

Also, it is possible to provide a robot path planning method that enables safe autonomous walking in an unstructured environment, such as mountains and disaster area, by updating a traversal risk graph for surrounding terrains in real time, regardless of presence or absence of a prior map through efficient traversal risk graph management. Also, in an environment in which sensor data is continuously updated, the example embodiment may quickly respond to an environmental change by updating only a local graph, and since a global graph is structurally managed, only a changed part may be modified without a need to reconstruct the entire graph. This hierarchical management may reduce a processor's computational amount and memory usage and may improve the real-time applicability.

Results from various simulations and actual environmental experiments show that a path generation rate and a path travel completion rate are significantly higher than those of the existing methods, and maintain an efficient computational amount in generating and managing a graph in real time. This has great potential for use in various platforms that prioritize posture stability, such as a walking robot (quadruped walking robot or humanoid robot), which needs to move in a safe and precise posture compared to a fast-moving platform, such as a drone and an autonomous vehicle, and may be more effective in a holonomic robot that may show a difference in a path entry direction. The robot according to the example embodiment described above may increase a success rate of autonomous walking in an arbitrary unstructured environment and thus, may be expanded to various fields, such as disaster relief, industrial site, forest management, and military.

Effects of the invention are not limited to contents described above and still other effects not described may be clearly understood by one of ordinary skill in the art from the description set forth herein.

Various example embodiments described herein may be implemented by hardware, middleware, microcode, software, and/or combinations thereof. For example, various example embodiments may be implemented within one or more application specific integrated circuits (ASICs), digital signal processors (DPSs), digital signal processing devices (DSPDs), programmable logical devices (PLDs), field programmable gate arrays (FPGAs), processors, controllers, microcontrollers, microprocessors, other electronic units designed to perform functions presented herein, or combinations thereof.

Such hardware and the like may be implemented within the same device or individual devices to support various operations and functions described herein. Additionally, components, units, modules, and the like described with “~unit” herein may be implemented together or individually as interoperable logic devices. Description of different features for modules and units are intended to highlight different functional embodiments and does not necessarily imply that these need to be realized by individual hardware components. Rather, functionality associated with one or more modules or units may be performed by individual hardware components or integrated within common or individual hardware components.

Although the example embodiments have been described with reference to the accompanying drawings, it is provided as an example only and one of ordinary skill in the art will understand that various modifications and equivalent other example embodiments are possible therefrom. Therefore, the true technical scope of the invention should be determined by the technical spirit of the claims.

What is claimed is:

1. A method for traversal risk graph-based robot path planning, the method comprising:
generating a plurality of paths by connecting a plurality of nodes of the terrain on which a robot is capable of standing and two nodes among the plurality of nodes as an edge, and generating a traversal risk graph (TRG) by considering reachability of the robot to a target node and terrain characteristics; and
searching for a path used for the robot to reach the target node based on the traversal risk graph.

2. The method of claim 1, wherein the generating of the traversal risk graph comprises determining whether each of the nodes is valid based on environmental information that includes the height of the terrain and movement stability of the robot, and removing an invalid node.

3. The method of claim 2, wherein the determining whether the node is valid comprises comparing the node and the median of the terrain height, and evaluating and determining whether the robot is capable of standing without losing its balance.

4. The method of claim 1, wherein the generating of the traversal risk graph comprises calculating the traversal risk of the robot by performing elliptical plane approximation for the edge, removing an edge of which the risk exceeds a preset reference value, and generating the traversal risk graph that allows the robot to safely move.

5. The method of claim 4, wherein the traversal risk is calculated by considering an angle of slope of the elliptical plane extracted through principal component analysis (PCA).

6. The method of claim 4, wherein, in response to expansion from a reference node in a wavefront manner, the traversal risk graph is expanded to an area reachable from a location of the robot and thereby generated by progressively sampling a surrounding area at the reference node and by recursively connecting the edge.

7. The method of claim 6, wherein an expansion method in the wavefront manner to generate and manage the traversal risk graph is to sample an adjacent area at the reference node of the robot, to merge nodes close by a predetermined distance or less from the reference node, and to connect an edge between the nodes.

8. The method of claim 1, further comprising:
updating a local graph based on terrain information corresponding to a sensor measurement range of the robot and reflecting the same to a global graph, to respond to a dynamic environmental change around the robot.

9. The method of claim 1, wherein the searching for the path comprises searching for the path using a cost function.

10. The method of claim 9, wherein the cost function is calculated in consideration of a length of a path candidate group of the edge and the traversal risk.

11. The method of claim 10, wherein the cost function includes a heuristic function based on a distance from the target node.

12. The method of claim 11, wherein, to minimize the cost function on the traversal risk graph, search is performed by calculating an arrival cost and an estimated heuristic cost for each node and search priority of a path in which the traversal risk of the edge is higher than a predetermined reference is lowered.

13. The method of claim 1, wherein, when the traversal risk of the edge exceeds a reference value, the edge is removed or the priority is lowered to exclude the edge when searching for a travel path.

14. The method of claim 1, wherein, when a new obstacle is detected or existing terrain information changes while the robot is walking, the traversal risk graph generates real-time path planning by partially updating information on nodes and edges connected to the corresponding terrain.

15. A device for generating traversal risk graph-based robot path planning, the device comprising:
a memory including measurement data of a sensor mounted to a robot and a computer-readable instruction; and
a processor configured to perform terrain map generation by processing the instruction,
wherein the processor is configured to,
generate a plurality of paths by connecting a plurality of nodes of the terrain on which a robot is capable of standing and two nodes among the plurality of nodes as an edge, and generate a traversal risk graph (TRG) by considering reachability of the robot to a target node and terrain characteristics, and
search for a path used for the robot to reach the target node based on the traversal risk graph.

16. The device of claim 15, wherein the processor is configured to generate the traversal risk graph by determining whether each of the nodes is valid based on environmental information that includes the height of the terrain and movement stability of the robot and by removing an invalid node.

17. The device of claim 15, wherein the processor is configured to search for the path using a cost function that considers a length of the path and the traversal risk together.
